(19) United States
(12) Patent Application Publication
(10) Pub. No.: US 2010/0269872 A1
(43) Pub. Date: Oct. 28, 2010

(54) ENHANCED CRUTCH WALKER

(76) Inventor: EDWARD THARP, Concord, NC (US)

Correspondence Address: Thien Tran/ Access Patent Group, LLC, 7706 Tanner Robert Court, Springfield, VA, 22153, US

(21) Appl. No.: 12/768,727

(22) Filed: Apr. 27, 2010

Related U.S. Application Data
(60) Provisional application No. 61/173,168, filed on Apr. 27, 2009.

(51) Int. Cl. A61H 3/02

(52) U.S. Cl. 135/66

(57) ABSTRACT

A knee support attachable to a medical crutch for supporting an injured or amputated knee of a user of the medical crutch is provided. The knee support is held in a first extended position when in use and a second folded position when not in use. The knee support includes a base plate affixed to the medical crutch for supporting a knee placed thereon, and a soft padding covering the base plate for providing a cushioned support to the knee placed thereon. The knee support provides hands-free feature for the user. The position of the base plate is adjustable along the holes or the length of the medical crutch.

### CROSS-REFERENCE TO RELATED APPLICATION

This application claims the benefit of Provisional Patent Application No. 61/173,168 filed on Apr. 27, 2009, in the United States Patent & Trademark Office, the disclosure of which is incorporated herein by reference.

### FIELD OF INVENTION

The present invention is directed towards medical devices. More particularly, the present invention provides an enhanced crutch walker which is designed to ease discomfort and reduce strain when walking with crutches. This invention provides a kit or add-on to a conventional crutch or axillary crutch wherein a detachable knee support which can be attached to a conventional forearm, elbow, or axillary crutch of single-tube design. When the knee of the user is placed onto a padded support area, the whole lower leg can be protected from weight bearing without having to put weight onto the armpits and hand grips instead. This is advantageous for users suffering from impaired arm function and it allows a relaxed posture on both legs while standing. In addition, the invention allows the use of a contoured knee pad and it provides a means to use the contoured knee pad freely when assuming a stationary standing posture and flip away or flip up the platform when not needed.

### BACKGROUND OF THE INVENTION

After an injury, many individuals are forced to use crutches to help them walk. In addition to the injured leg, using crutches can cause additional soreness and discomfort. Extreme pressure is placed on the hands when they grip the handles, which can make it difficult to remain in a standing position. The functioning leg is responsible for the residual weight of the body and this can become extremely tiring. The armpit area can become chafed and irritated, which can often be more uncomfortable than the actual injury. A crutch designed in a manner that distributes the weight more evenly would help to alleviate some of the pain.

Leg injuries are not a new issue for humans, and ancient artwork suggests that crutches may have provided a solution even as early as 5000 years ago. Since then, crutches have progressed from primitive structures such as T-shaped sticks to sophisticated lightweight ergonomic tools.

Several major classes of crutches exist today, which include, underarm, forearm, platform, and knee support crutches. Underarm or axillaries crutches are most common in the United States and are typically used by persons having a temporary disability or injury. These crutches have a pad that rests in the armpits and against the rib cage, and a grip along the length of the crutch that allows a user to grasp the crutch for stabilization. Underarm crutches are used temporarily because they tend to be uncomfortable and cumbersome for users.

The discomfort caused by the pad under a user's arm, the strength required to hold the handles, and lack of hands-free operation makes this type of crutch less than ideal.

United States (US) Patent Application no. 20090229643 discloses a leg supporting crutch system and method. The crutch system comprises a supporting member and a stabilizing member.

US Patent Application no. 20030098051 discloses a detachable knee or lower leg support system for crutches.

US Patent Application no. 20090235966 discloses an ergonomic design for crutches. The application discloses a knee rest assembly pivotally mounted to tubular member at a predetermined desired distance from the either end of a crutch. The assembly provides sufficient resting area for a user to lean against with his knee.

US Patent Application no. 20070012345 discloses a lower limb-support ambulatory device. The Application describes a lower limb, e.g. bent knee, supporting device which includes a lower limb supporting brace including at an upper extreme thereof and aligned with a long axis thereof a cushioned limb support member; an elongate angled stabilizing handle or member for stabilizing the brace, the handle extending upwardly and outwardly from the brace at an angle thereto, the handle being securely grippable by a user without use of the armpit; the device including below the stabilizing member and brace at a lower extreme thereof a tip configured to frictionally engage an ambulatory surface.

US Patent Application no. 20070251560 describes an orthopedic knee crutch wherein a distance between the feet and knee contact point is adjustable to accommodate users of various heights.

US Patent Application no. 20100051075 discloses a convertible mechanism that folds out from the crutch to become a chair. Thus, the present invention provides for a need in the art for a simple and universal technique to provide a way for persons using crutches to rest. The technique uses a design that is unobtrusive, lightweight, opens and closes quickly with minimum force, fits the size demographic, and provides a chair, any time, any place.

Further, US Patent Application no. 20090151761 discloses a calf, ankle, foot, or leg rest device (hereinafter, Resting Device) and a cane modified by having the Resting Device movably mounted thereon.

Most of the devices available for providing support to an injured leg require purchasing specialized equipment which in some cases may not be economical. Accordingly, there is a need for a simple and easy to use medical device designed to ease discomfort and reduce strain when walking with crutches. There is need for a crutch walker which allows individuals to walk more comfortably, taking pressure off of their armpits and standing leg. And also permits users to stand without balancing with their hands. The present invention satisfies these needs, as well as others, and generally overcomes the deficiencies found in the background art.

Crutches have taken many forms over the years, and all have been designed to permit a user to ambulate while protecting a leg, that is to be able to ambulate without the need to place all or part of the user's body weight on the user's leg(s). Even so, known crutches have not addressed the needs of many users to be able to rest the affected leg by supporting it while standing for long periods of time.

This invention addresses this long felt and unmet need by providing a leg support that can be readily attached to a conventional crutch, and which provides a support whereon the user can rest the affected leg. And the leg support can be retracted to an upright position to stow the knee platform as needed. The invention will now be described in detail with reference to the drawings.

### SUMMARY OF THE INVENTION

The present invention is directed towards medical devices and provides an enhanced crutch walker which is designed to ease discomfort and reduce strain when walking with crutches. The crutch walker device is a modification to existing crutches that enables users to rest their injured leg on a knee support. The knee support is provided coupled to a crutch and can be folded when not in use.

In an embodiment of the present invention, a knee support attachable to a medical crutch for supporting a knee of a user of the medical crutch is provided. The knee support is held in a first extended position when in use and a second folded position when not in use. The knee support comprises a base plate affixed to the medical crutch for supporting a knee placed thereon, and a soft padding covering the base plate for providing a cushioned support to the knee placed thereon. The position of the base plate is adjustable along the length of the medical crutch. The base plate is composed of a metal or a plastic material. Further, the knee support is attached to the medical crutch by using one or more clamps or screws. The position of the base plate along the length of the medical crutch is adjustable based on the user's height for placing the user's knee on the base plate. Also, the knee support supports the user's knee and corresponding leg without requiring the user's hands to hold the medical crutch.

In another embodiment, a medical crutch comprising a knee support affixed thereto, for supporting a knee of a user of the medical crutch, the knee support being held in a first extended position when in use and a second folded position when not in use. The knee support comprises a base plate affixed to the medical crutch for supporting a knee placed thereon, and a soft padding covering the base plate for providing a cushioned support to the knee placed thereon. The base plate is composed of a metal or a plastic material. Further, the knee support is attached to the medical crutch by using one or more clamps or screws. The position of the base plate along the length of the medical crutch is adjustable based on the user's height for placing the user's knee on the base plate.

This invention provides a kit or add-on to a conventional crutch which is retractable. The invention allows the use of a contoured knee pad and it provides means to use the contoured knee pad freely when assuming a stationary standing posture and flip away or flip up and stow the platform when not needed preferably by a friction means. The present invention relates to a retractable knee platform for use with a crutch for supporting the leg of a user, and having a memory foam cushioned upper surface. The retractable knee platform is preferably adjustable to varying heights on the crutch. This invention provides a kit or add-on to a conventional crutch or a medical crutch wherein a detachable knee support which can be attached to a conventional forearm, elbow, or a medical crutch of single-tube design. When the knee of the user is placed onto a padded support area, the whole lower leg can be protected from weight bearing without having to put weight onto the armpits and hand only instead. This is advantageous for users suffering from impaired arm function and it allows a relaxed posture on both legs while standing. In addition, the invention allows the use of a contoured knee pad (with a memory foam cushioned upper surface) and it provides means to use the contoured knee pad freely when assuming a stationary standing posture and flip away or flip up the platform when not needed as when ambulating.

### BRIEF DESCRIPTION OF THE ACCOMPANYING DRAWINGS

The present invention is described by way of embodiments illustrated in the accompanying drawings wherein:

FIG. 1A illustrates the enhanced crutch walker in an extended position, in accordance with an embodiment of the present invention;

FIG. 1B illustrates the enhanced crutch walker in a folded position, in accordance with an embodiment of the present invention;

FIG. 2 illustrates the enhanced crutch walker being used by a user in a standing position, in accordance with an embodiment of the present invention;

FIG. 3 illustrates the enhanced crutch walker being used with the knee support folded up, in accordance with an embodiment of the present invention;

FIG. 4 illustrates the enhanced crutch walker being used to support a knee of an injured leg, in accordance with an embodiment of the present invention;

FIG. 5 illustrates an injured knee being supported by the knee support of the enhanced crutch walker, in accordance with an embodiment of the present invention; and

FIG. 6 illustrates a detailed view of the knee support.

### DETAILED DESCRIPTION OF THE INVENTION

The present invention provides an enhanced crutch walker which is designed to ease discomfort and reduce strain when walking with crutches. The crutch walker device is a modification to existing crutches that enables users to rest their injured leg on a knee support. The knee support is provided coupled to a crutch and can be folded when not in use.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

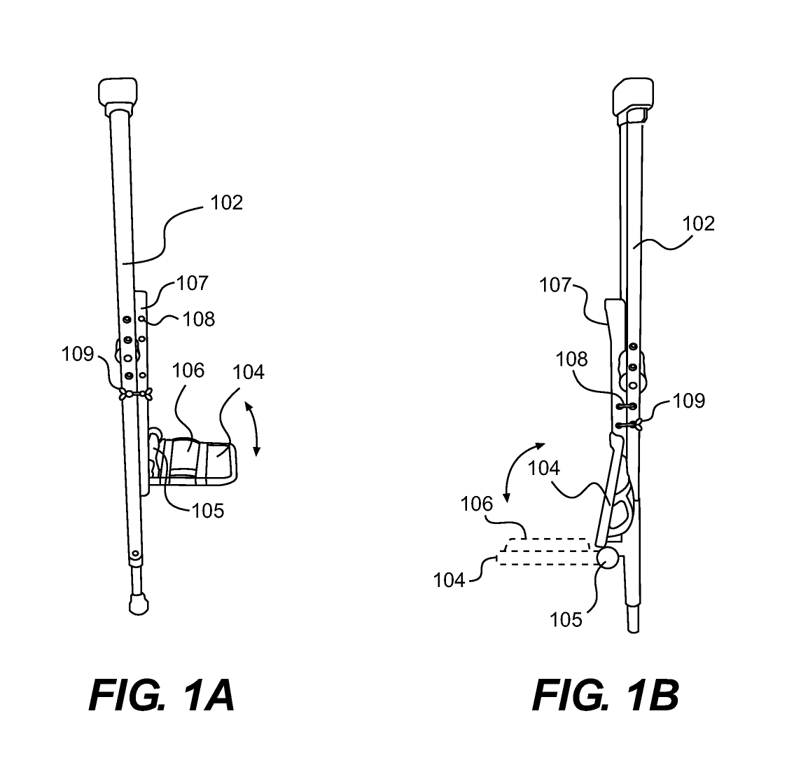

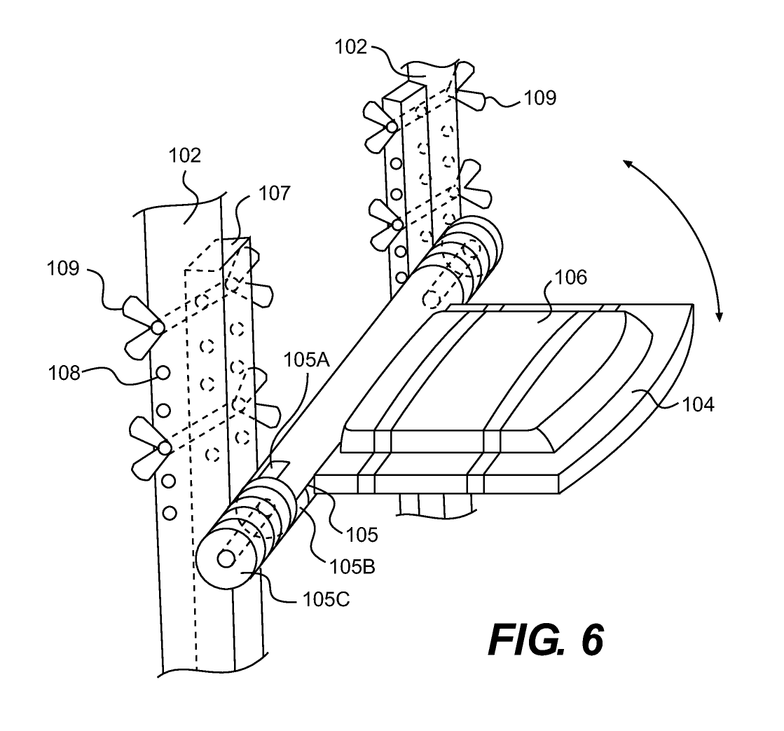

FIG. 1A illustrates the enhanced crutch walker in an extended position, in accordance with an embodiment of the present invention. The enhanced crutch walker 102 provides a space to rest an injured leg when using crutches. The crutch walker 102 is designed by affixing a foldable knee support or base plate 104 to a side of a standard medical crutch. The foldable knee support or base plate 104 is attached to two extended bars 107 via a shaft 105. The two extended bars 107 are affixed to both end clamp members 105C. The foldable knee support or base plate 104 can be folded via the shaft 105 in two positions: horizontal position (unfolded position 105B as in FIG. 6) and vertical position (folded position 105A as in FIG. 6). The two extended bars 107 have an array of holes 108 to match with existing holes of the crutch 102. The two extended bars 107 are tied or clamped to the crutch 102 by wing-nuts 109 via the holes 108. The holes 108 are aligned and selected to adjust the height of the knee support or base plate 104 comparing to the ground.

A user may use the knee support 104 to rest the knee of an injured leg while walking or while standing, thereby easing pressure off the other uninjured leg as well as the user's armpits which support the crutch. In an embodiment of the present invention, the knee support or base plate 104 is mounted on a standard medical crutch by using clamps and screws at approximately knee level. In various embodiments, the knee support or base plate 104 is mounted in a manner that allows for height adjustments, so that the position of the knee support or base plate 104 on the crutch walker 102 may be adjusted to accommodate a user's height enabling the knee support or base plate 104 to be placed at the user's knee level.

In an embodiment of the present invention, the knee support or base plate 104 is designed using any durable material such as metals or plastics commonly known in the art for manufacturing standard medical crutches. The metal knee support 104 is covered with a soft foam padding 106 (with memory foam cushioned upper surface) to provide comfort for the user's knee. In an embodiment, the knee support or base plate 104 resembles a tray made of a firm durable material such as metal or plastic covered with a soft padding material 106 to provide support. The size of the knee support 104 is 4×5 inches, 4×6 inches, 4×8 inches, 5×6 inches, and 5×8 inches. In various embodiments the knee support or base plate 104 is foldable and may be folded when not in use (in vertical position as in FIG. 1B). In an embodiment, the knee support or base plate 104 is clamped to the side of a standard medical crutch by wing-nuts 109. The knee support or base plate 104 facilitates folding in an upright direction or vertical position when not in use.

FIG. 1B illustrates the enhanced crutch walker in a folded position, in accordance with an embodiment of the present invention. As illustrated in the FIG. 1B, when folded the knee support 104 is substantially parallel to the crutch walker 102. In various embodiments, the knee support 104 may be designed to be easily foldable or flippable in any manner which facilitates a user to use the crutch walker 102 unhindered by the knee support 104. The foldable design of the knee support 104 enables a user to extend the same for use and then fold it away when not in use. In an embodiment, folding mechanism may be used to fold the knee support 104 as in FIG. 6.

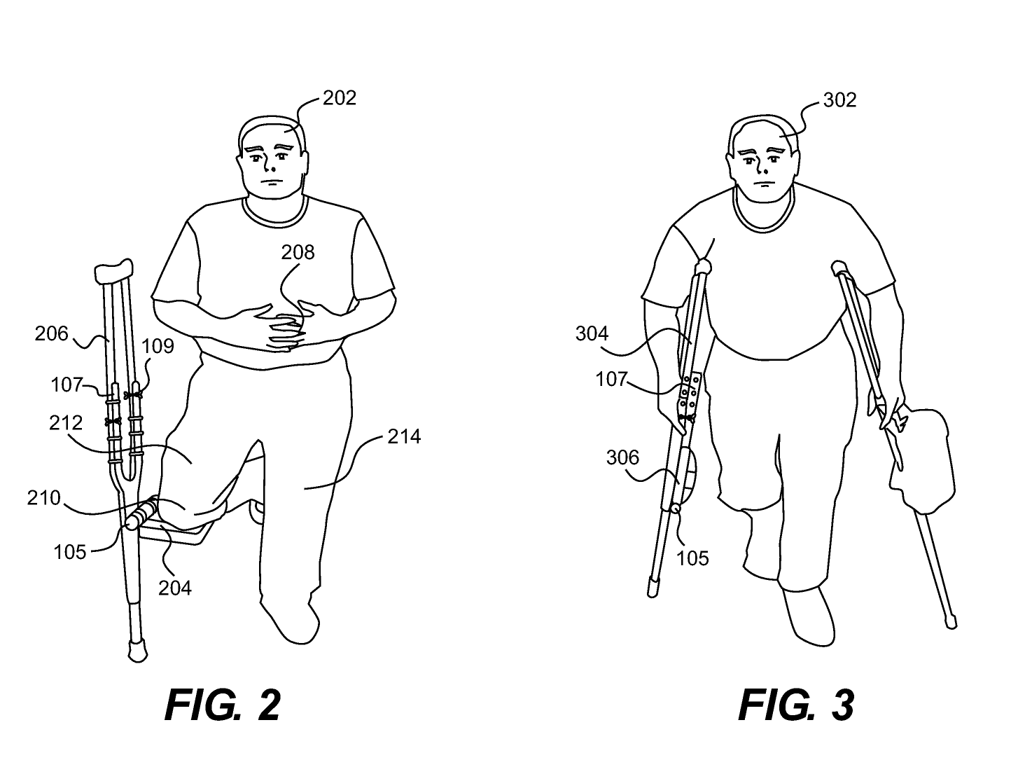

FIG. 2 illustrates the enhanced crutch walker being used by a user in a standing position, in accordance with an embodiment of the present invention. The user 202 is using the knee support 204 to stand in an upright position without supporting the crutch walker 206 with his hands 208 (hands-free feature). As illustrated in FIG. 2 the user 202 has placed a knee 210 of his injured leg 212 on the knee support 204 in order to stand at one place. Also, as illustrated the knee support 204 has enabled the user 202 to keep his hands 208 free. Hence, the knee support 204 has eliminated the need of using hands or armpits to support the crutch 206 while standing, thus providing relief to the hands and/or armpits. Also, the use of the knee support 204 as illustrated in FIG. 2 eases the pressure off the user's 202 uninjured leg 214.

FIG. 3 illustrates the enhanced crutch walker being used with the knee support folded up, in accordance with an embodiment of the present invention. The knee support 204 provided with the enhanced crutch walker of the present invention may be folded up when not in use so as to not interfere with the normal functioning of the crutch walker similar to that of a standard medical crutch. As illustrated in FIG. 3 a user 302 is using the enhanced crutch walker 304 in a manner similar to a standard medical crutch with the knee support 306 folded out of the way via a shaft 105.

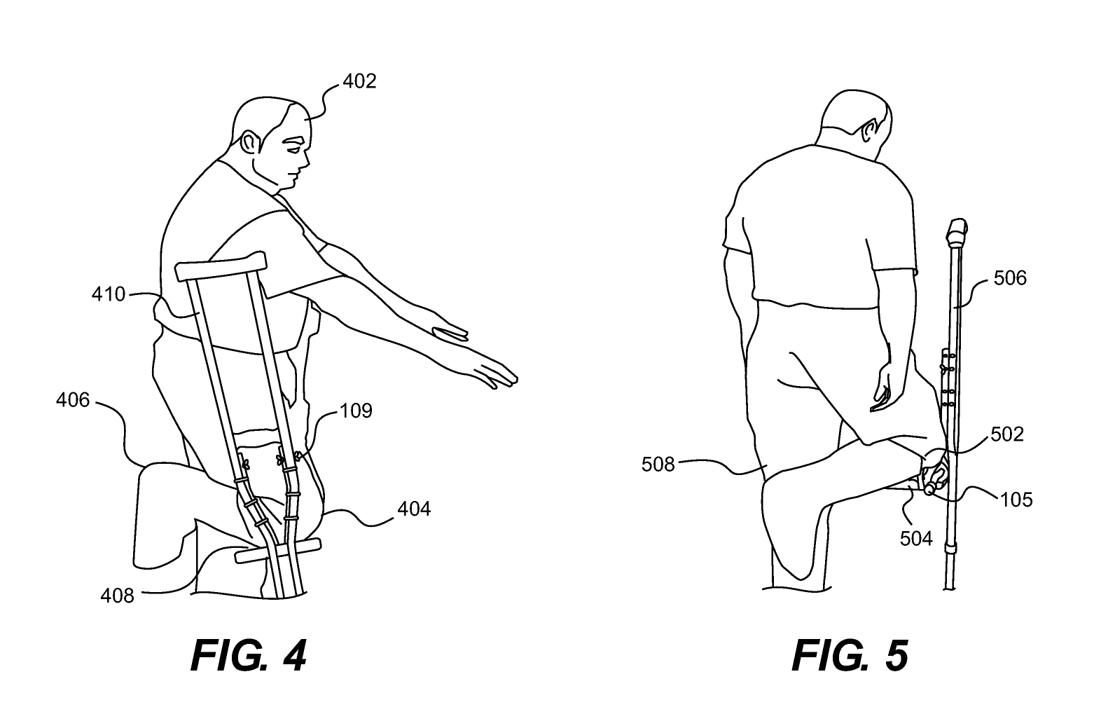

FIG. 4 illustrates the enhanced crutch walker being used to support a knee of an injured leg, in accordance with an embodiment of the present invention. The knee support provided with the crutch walker enables a user to free his hands while in a standing position. As illustrated in FIG. 4, a user 402 has rested the knee 404 of his injured leg 406 on a knee support 408 of the crutch walker 410, thereby freeing his hands 412 for performing other activities such as unlocking a door.

FIG. 5 illustrates an injured knee being supported by the knee support of the enhanced crutch walker, in accordance with an embodiment of the present invention. As illustrated in the figure an injured knee 502 can be comfortably supported on a knee support 504 of an enhanced crutch walker 506. The placement of the knee 502 on the knee support 504 reduces the pressure that is applied on an uninjured leg 508. Also the use of the knee support provides rest to the injured knee/leg 502 and frees the user's hands for performing tasks other than holding onto a crutch.

FIG. 6 illustrates a detailed view of the knee support attached to an enhanced crutch walker, in accordance with an embodiment of the present invention. The enhanced crutch walker 102 provides a space to rest an injured leg when using crutches. The crutch walker 102 is designed by affixing two extended bars 107 of a foldable knee support 104 to both tubes or rails of a standard medical crutch 102. The foldable knee support 104 is attached to two extended bars 107 via a shaft 105. The foldable knee support 104 can be folded or pivoting via the shaft 105 in two positions: horizontal position (unfolded position) and vertical position (folded position) or 90° degree rotation between horizontal position 105B and vertical position 105A. The two extended bars 107 have holes 108 to match with existing holes of the crutch 102. The two extended bars 107 are tied to the crutch 102 by wing-nuts 109. The two extended bars 107 are affixed to both end clamp members 105C.

Therefore the present invention provides an enhanced crutch walker for providing people with leg injuries a measure of convenience and comfort. The enhanced crutch walker of the present invention allows individuals having an injured/disabled leg to walk more comfortably, taking pressure off from the armpits and the uninjured leg. The knee support provided with the enhanced crutch walker permits users to stand without balancing with their hands, thereby freeing their hands for performing other tasks. Hence, the enhanced crutch walker provided herein is ideal for those walking with crutches and dealing with the strain of the process. The crutch walker helps to support the functioning leg, while providing a safe space for the injured limb.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

What is claimed is:

1. A knee support attachable to a medical crutch for supporting a knee of a user of the medical crutch, the knee support being held in a first extended position when in use and a second folded position when not in use, the knee support comprising:
a. a base plate is attached to a shaft being freely folding in both end clamp members;
b. two extended bars are affixed to both said end clamp members; wherein the two extended bars having holes to match with existing holes of two rails of the crutch;
c. a plurality of wing-nuts are used to clamp the holes of said two extended bars into the existing holes of the medical crutch; wherein the position of the base plate being adjustable along the existing holes of the medical crutch in order to achieve a desired height of the base plate; and
d. a soft padding covering the base plate for providing a cushioned support to the knee placed thereon.

2. The knee support as claimed in claim 1 wherein the base plate is composed of a metal material.

3. The knee support as claimed in claim 1 wherein the base plate is composed of a plastic material.

4. The knee support as claimed in claim 1 wherein the size of the knee support is selected from a group consisting of 4×5 inches, 4×6 inches, 4×8 inches, 5×6 inches, and 5×8 inches.

5. The knee support as claimed in claim 1 wherein the soft padding is composed of a memory foam cushioned upper surface.

6. The knee support as claimed in claim 1, wherein the base plate supporting the user's knee and corresponding leg without requiring the user's hands to hold the medical crutch.

7. A medical crutch comprising a knee support affixed thereto for supporting a knee of a user of the medical crutch, the knee support being held in a first extended position when in use and a second folded position when not in use, the knee support comprising:
a. a base plate is attached to a shaft being freely folding in both end clamp members;
b. two extended bars are affixed to both said end clamp members; wherein the two extended bars having holes to align with existing holes of the crutch;
c. a plurality of wing-nuts are used to clamp the holes of said two extended bars into the existing holes of the medical crutch;
d. a height of the base plate is being adjusted along the existing holes of the medical crutch in order to achieve a desired height of the base plate; and
e) a soft padding covering the base plate for providing a cushioned sup port to the knee placed thereon.

8. The medical crutch as claimed in claim 7 wherein the base plate is composed of a metal material.

9. The medical crutch as claimed in claim 7 wherein the base plate is composed of a plastic material.

10. The knee support as claimed in claim 7 wherein the soft padding is composed of a memory foam cushioned upper surface.
